(19) United States
(12) Patent Application Publication
(10) Pub. No.: US 2018/0130240 A1
(43) Pub. Date: May 10, 2018

(54) DISPLAYING VISUALIZATION IMAGES ON PORTABLE ELECTRONIC DEVICE

(71) Applicant: SAP SE, Walldorf (DE)

(72) Inventors: SANJEET MALL, PLEASANTON, CA (US); CHRIS JOBSON, Pleasanton (DE); VIVEK PAHARIA, Pleasanton (DE); MARKUS HUECK, Pleasanton (DE); DIRK GROSSKOPF, Pleasanton (DE); TAMAS JOZSA, Pleasanton (DE); LASZLO CSABA PINTER, Pleasanton (DE)

(21) Appl. No.: 15/343,368

(22) Filed: Nov. 4, 2016

(51) Int. Cl. G06T 11/60; G06F 17/24; G06F 17/22; G06T 1/00; G06F 3/0482

(52) U.S. Cl. CPC G06T 11/60; G06F 17/248; G06F 3/0482; G06T 1/0007; G06F 17/2211

(57) ABSTRACT

A method and system displaying a plurality of visualizations at a portable electronic device is described. Initially a data presentation application executing at the portable electronic device renders a plurality of visualizations based on a user interface (UI) visualization file. A plurality of screenshots are captured corresponding to the rendered plurality of visualizations. Next a plurality of visualization images are generated by rendering the visualization screenshots at one surface of the plurality of visualizations and metadata related to the data on another surface of the plurality of visualization images. Finally, the generated plurality of visualization images are displayed at a user interface of the portable electronic device.

### BACKGROUND

Portable electronic devices, for example mobile phones, tablets, etc., are increasingly becoming the primary device for accessing data as compared to desktop/laptop computers. The portable electronic devices are used to access E-Mails, news, data, etc.

Typically, when a data is obtained by executing several process steps then the entire process needs to be executed at the portable electronic device. This may consume a considerable amount of memory and processing time of the portable electronic device, which is undesirable.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG. 1 is a block diagram illustrating a system to display a visualization image on a portable electronic device, according to an embodiment.

FIG. 2 is a flow diagram illustrating a process to store a visualization template and visualization instance identifier at an UI service, according to an embodiment.

FIGS. 3A-3C is a flow diagram illustrating a process to display visualization image at the portable electronic device, according to an embodiment.

FIG. 4 is a block diagram illustrating a system to display visualization images, according to an embodiment.

FIG. 5 is an exemplary block diagram illustrating a user interface of a portable electronic device displaying several visualization images, according to an embodiment.

FIG. 6 is an exemplary block diagram illustrating a user interface of a portable electronic device displaying a surface of a visualization image when one of the visualization image is selected, according to an embodiment.

FIG. 7 is an exemplary block diagram illustrating a user interface of a portable electronic device displaying another surface of a visualization image displayed in FIG. 6, according to an embodiment.

FIG. 8 is a block diagram illustrating an exemplary computer system, according to one embodiment.

### DETAILED DESCRIPTION

Embodiments of system and method for displaying visualization images on portable electronic device are described herein. In the following description, numerous specific details are set forth to provide a thorough understanding of the embodiments. A person of ordinary skill in the relevant art will recognize, however, that the embodiments can be practiced without one or more of the specific details, or with other methods, components, materials, etc. In some instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

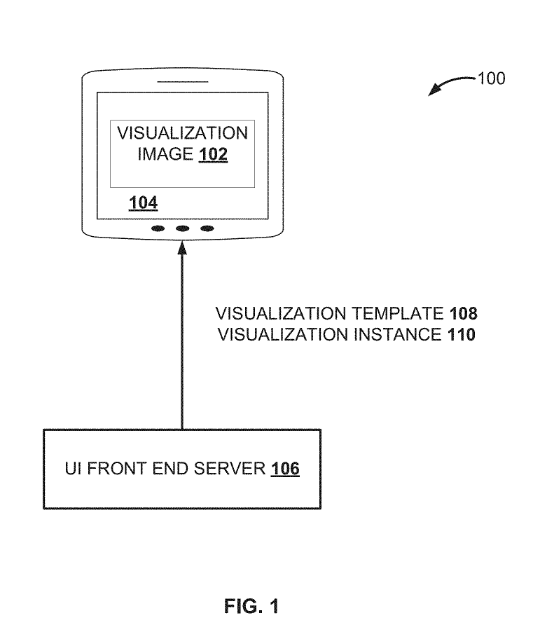

FIG. 1 is a block diagram illustrating a system 100 to display a visualization image 102 on a portable electronic device 104, according to an embodiment. The system includes a user interface (UI) frontend server 106 that stores visualization template 108 and visualization instance 110. A UI frontend server 106 may include the components for displaying data on a UI. In one embodiment, the UI may be a UI of a portable electronic device 104. A portable electronic device 104 may be, for example, a smartphone, tablets, wearable devices, etc. A visualization template 108 is a pre-defined UI template that defines a particular arrangement of data on the UI. For example, a visualization template 108 may define that a “title” data is to be shown at the top portion of the UI, menu items are to be shown at right side of screen, etc. In one embodiment the visualization template 108 may be SAP Fiori® smart template.

The visualization template 108 may also include connection definitions for establishing a connection to a data source that provides data to be populated at the visualization template. The connection definitions may include, for example, Open data (Odata) service definition that provides a connection information to connect with a data source and a metadata of the data at the data source exposed by the Odata service. In one embodiment, the visualization instance 110 defines visualization preference for a particular instance of UI rendering. For example, a visualization instance may define that when rendering a sales order for a particular user a header section should display the name of the user and the date when the last sales order is generated.

The visualization template 108 and the visualization instance 110 are then forwarded to a data presentation application (app) installed at the portable electronic device 104. A visualization is then rendered based on the visualization template 108, the visualization instance 110, and the data retrieved from the data source based on the connection definition included in the visualization template 108. In one embodiment, the visualization may be rendered at a hidden web view that does not display the rendered visualization at the UI of the portable electronic device 104. In one embodiment, a screenshot of the rendered visualization may then be captured to obtain a visualization screenshot. In one embodiment, the captured visualization screenshot may be rendered at one surface of a visualization image 102 and a metadata of the data populated at the visualization on another surface of the visualization image. For example, one of the surface of the visualization image may include customer information and a number of product a customer bought. The other surface may include details of the product bought by the customer. The generated visualization image 102 is then displayed at the UI of the portable electronic device 104.

The generated visualization image 102 allows a user to easily view the data stored in the data source at the portable electronic device without executing the data generation process at the portable electronic device. This reduces the amount of portable electronic device memory required for displaying the data to a user.

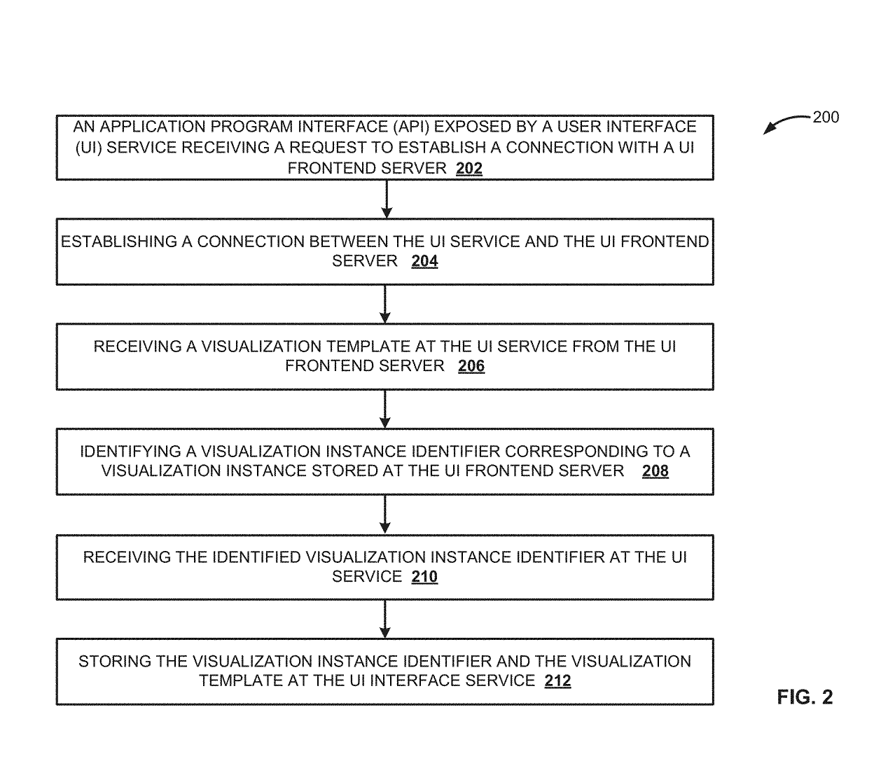

FIG. 2 is a flow diagram 200 illustrating a process to store a visualization template and visualization instance identifier at an UI service, according to an embodiment. Initially an application program interface (API) exposed by a UI service 202 receives a request to establish a connection with a UI frontend server. In one embodiment, the UI service is a cloud service hosted in a cloud platform, for example, SAP Hana® Cloud platform. A cloud service is a service or resource provided over the internet. The UI frontend server may invoke an API exposed by the UI service to establish a connection between the UI frontend server and the UI service. In one embodiment, the UI frontend server, for example, is a SAP Fiori® frontend server. The UI frontend server includes several components for rendering a visualization.

The UI frontend server may include a UI library that stores pre-defined visualization templates for rendering a visualization. A pre-defined visualization template defines a pattern for rendering a visualization. For example, a pre-defined visualization template may define the position of a header on top of a visualization and footer at bottom of the visualization. In one embodiment, the visualization template includes a list of visualization template classes and visualization template types. A visualization template class defines a template that may be used to visualize any data. For example, in SAP Fiori® the visualization template may include: a SAP Fiori® overview Page, a SAP Fiori® object page, or a Hyper Text Markup Language (HTML) template. The SAP Fiori® overview page provides a summary of data on a single page. The SAP Fiori® overview page contains the components: Application Header, filter, and Cards. An application header provides information, for example, procurement data, related to the data displayed at the portable electronic device. The filter defines the portion of data that is to be displayed at the overview page, for example sales above 50000$. The card is a visualization instance that uses UI annotation to render content. A card is bound to a single entity set in a data source. An entity set is a collection of entities that are of same type. For example, an entity set “books” can include the three entities “book 1”, “book 2” and “book 3”.

A SAP Fiori® object page allows a user to display, create, and edit objects, and save drafts. The SAP Fiori® object page may be used for simple or complex objects. An object page includes: page title, object header, buttons in header toolbar, header facets to show information related to an object, anchor navigation area, content area, and footer bar. The HTML template use customer-supplied HTML with embedded binding syntax. The HTML is rendered and “bound” using a context determined by the visualization type and visualization instance of the visualization that is to be rendered.

The visualization type template is a visualization template class defined to visualize a particular data. For example, a procurement visualization type template may be defined for rendering visualizations related to procurement data and a sales order visualization type template may be defined for rendering visualizations related to sales order data. In one embodiment, the different visualization type template may correspond to one of the visualization class templates. For example, a procurement visualization type template may correspond to an overview page template. In this case, the procurement visualization type template may be defined to display the procurement data on an overview page.

In one embodiment, a manifest file is provided corresponding to the visualization class template and visualization type template. A manifest file is a file that includes a visualization generating information for generating a visualization corresponding to the visualization class template and visualization type template. The manifest file may include, for example, UI classes for the visualization class template and visualization type template, data connection information that provides information for retrieving data from a data source when rendering the visualization. For example, an object page manifest file may include:

{

“version” : “1.0.0”

}

An example of a visualization type template corresponding to the object page may have a manifest file including:

{
“version” : “1.0.0”,

“class”: “sap.c2g.fiori.Objectpage”,
“entity Set”: “<Odata entity set name>”,
“dataService” : {

```
  “metadata”: “<path to OData metadata>”,
“annotations” : [
  “path to annotation XML>”,
  “<additional annotation XML files as required>”
```

]

}
}

The UI frontend server also includes a data connection information for connecting the frontend server with other systems. For example, the data connection information may facilitate connecting the frontend server with a data source or an application. In one embodiment, the data connection information at the UI frontend server may be related to SAP® gateway, for example, which facilitates connection between the frontend server and any SAP® or non-SAP® system. The connection information may include an Open data (Odata) service information that exposes an entity data model (EDM) of data stored in a data source to the UI frontend server.

Next a connection is established between the UI frontend server and the UI service based on the received request (204). The visualization template file is then received at the UI service from the UI frontend server based on the established connection (206). In one embodiment, the visualization template manifest file is received at the UI frontend server based on the established connection. Next visualization instance identifiers corresponding to the visualization instances are identified (208). A visualization instance identifier, for example an app id, uniquely identifies a visualization instance. The visualization instance identifiers of each of the visualization instances stored in the UI frontend server are identified by the UI server. The UI frontend server may also identify visualization instance identifiers of visualization instances stored in other third party systems. In one embodiment, the visualization instance may be directly received at a user interface provided to the cloud hosting the UI service. A visualization instance may either be a pre-defined visualization instance stored in the UI frontend server or may be a visualization instance defined by a user. The visualization instance includes specific user preference for the visualization. The visualization instance defined by the user may include, for example, user defined modification for different areas of the visualization, details about the data that has to be visualized for the particular instance of visualization. For example, a visualization instance manifest file may include:

```
{“version”: “1.0.0”,
  “type” : “<type GUID>”,
  “dataUri” : “<Odata service root>”,
“entitySet” : “<Odata entity set name>,
“datapath” : <”path to file containing JSON data”>,
“cardId”: “<card ID>”,
“cardDetails” : {
```

```
  “model” : “<entity set>”,
  “template” : “<overview page template to use>”,
  “settings” : {
```

```
“title”: “{{<title key>}}”;
  “sub Title” : “{{<sub title key>}}”,
  “selectionAnnotationPath” : “<annotation path>”,
```

“entitySet” : “<entity set>”

}
}

}

The visualization template identifier, identified by the UI frontend server, may then be received at the UI service (210). Finally the received visualization identifier and the visualization template are stored at the UI service (212). In one embodiment, the received visualization identifier and the visualization template manifest file are stored at the UI service.

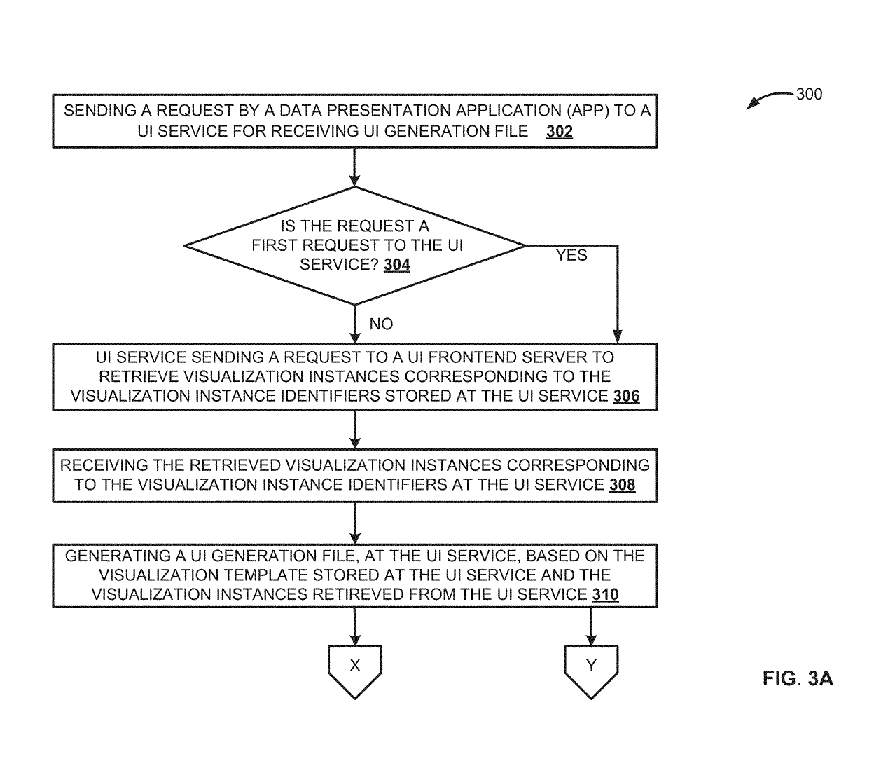

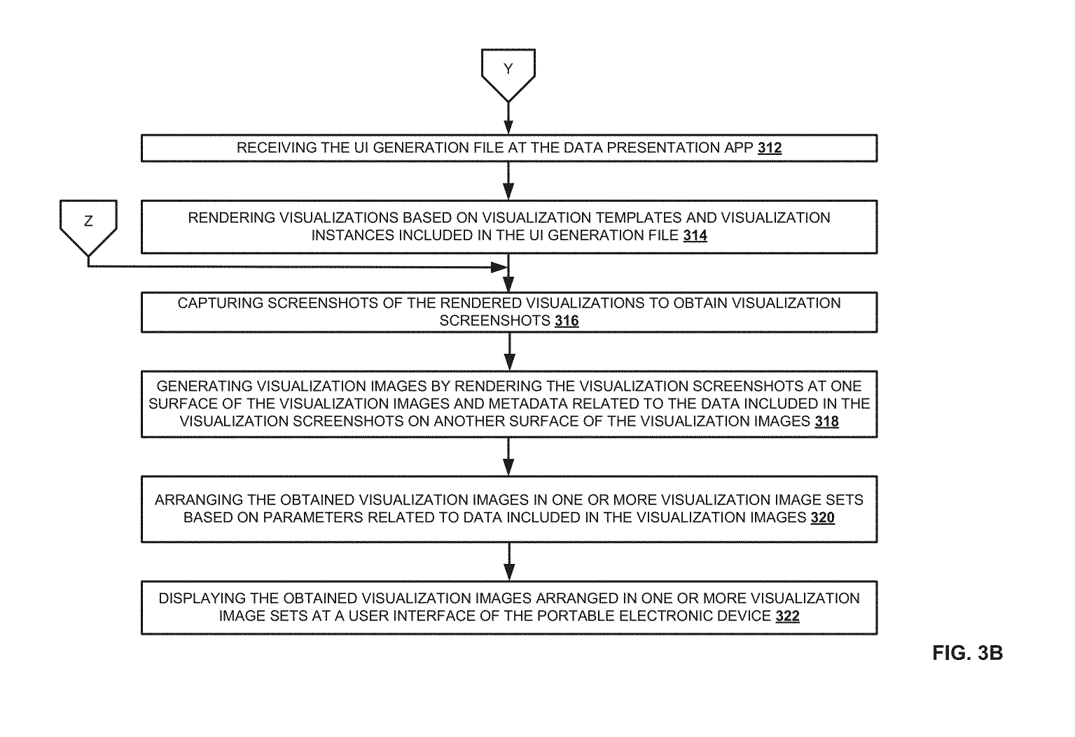

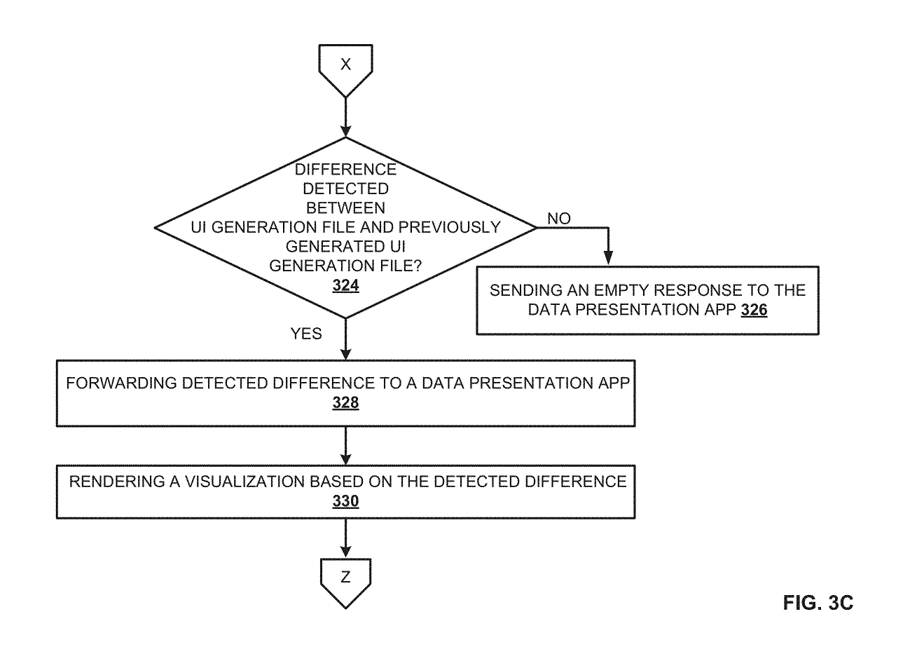

FIG. 3A-3C is a flow diagram 300 illustrating a process to display visualization image at the portable electronic device, according to an embodiment. In one embodiment, a visualization image is a static image of a visualization generated based on the visualization template and visualization instance. Initially a request is sent by a data presentation application (app) to a UI service for receiving a UI generation file (302). A data presentation app may have several components including a UI rendering coordinator, a UI component, and a web view. In one embodiment, the UI rendering coordinator is defined to connect the data presentation app to the UI Frontend Server. The UI rendering coordinator is also defined to decompress the UI generation file and co-ordinate the rendering of the visualization image. A web view is a system component that allows an operating system of the portable electronic device to display content from the web directly at an application. The different web pages may be loaded into the web view. The web view allows interacting with these web pages. In one embodiment, the web view is a hidden web view that does not display the web pages at the user interface of the portable electronic device. The web view also includes a rendering logic that defines one or more steps to render a visualization. In one embodiment, the web view includes user interface library, for example SAP® User Interface for HTML5 (UI5) library, which includes a collection of utilities and controls for generating a user interface. The UI component displays visualization images at the user interface of the portable electronic device. In one embodiment, the received request includes a time stamp indicating the time when the request is sent by the data presentation app to the UI service.

Next a check is performed to determine whether the request, send at 302, is a first request to the UI service (304). The request may be a first request when the request does not include a timestamp. In case, the request is a first request (condition in 304 is true) then the UI service sends a request to the UI frontend server to retrieve visualization instances corresponding to the visualization instances identifier stored at the UI service (306). Next the retrieved visualization instances corresponding to the visualization instance identifiers are received at the UI service (308). A UI generation file is then generated based on the visualization instance manifest file stored at the UI service and the retrieved visualization instance are then compressed, at the UI service, to obtain a UI generation file (310). In one embodiment, the visualization template and visualization instances may be compressed, for example, in a zip file, to obtain the UI generation file. The obtained UI generation file includes the visualization template manifest file, a visualization instance manifest file, and a compression manifest file.

The UI generation file is then received at the data presentation app (312). In one embodiment, the UI generation file includes the manifest files corresponding to all visualization templates and the visualization instances received by the UI frontend server or third party systems. Visualizations are then rendered based on the manifest files corresponding to visualization templates and visualization instances included in the UI generation file (314). In one embodiment, the visualizations may be rendered based on the manifest files corresponding to visualization templates and visualization instances included in the UI generation file. The visualization may be a webpage scaled according to the UI of the portable electronic device. The obtained visualization may be embedded in a hidden web view. A hidden web view is a web view that does not display the visualizations embedded in the hidden web view at a user interface of the portable electronic device.

The web view includes a rendering logic that defines the steps for rendering the visualization. The web view processes the manifest files of visualization templates and visualization instances, included in the received UI generation file, based on the rendering logic to render the visualization. For example, the rendering logic may define that initially a UI generation file is to be decompressed, a visualization template manifest file and a manifest file corresponding to SAP Fiori® Overview page template and a SAP Fiori® overview page instance are to be processed for generating the visualization image. The SAP Fiori® overview page template provides information about the different UI components that are to be included in the visualization and the data model of the data corresponding to the SAP Fiori® overview page template. The SAP Fiori® overview page instance includes specific information, for example a database table that is to be used for generating the visualization, which is to be bound to the generated SAP Fiori® overview page for generating the visualization.

In one embodiment, the rendering logic may use an UI library, for example SAP® UI Development Kit for HTML5 (SAPUI5), that provide different UI controls, such as buttons, and data binding functionality for populating data to the rendered UI visualization. The UI library may include a library to provide UI control for portable electronic device. This library may provide UI controls that are scaled according to the UI of the portable electronic device. The rendering logic uses the UI library to create different UI controls for the visualization based on the visualization template manifest file and visualization instance manifest file included in the visualization template.

In one embodiment, the rendering logic may also render a derived data corresponding to the data stored in the data source. A derived data may include, for example, data, image, voice message, or data in any other format, obtained based on the data stored in the data source. For example, when the underlying data is a table storing company name and company profits a derived data may be a bar chart showing the company name and company profits of top 10 companies with highest profits. In one embodiment, the visualization template may display only the derived data at the visualization.

Next, screenshots of the rendered visualizations is captured to obtain visualization screenshots (316). The rendering logic defines step to capture the screenshots of the rendered visualizations. A screenshot is a static image, for example a Portable Network Graphics (PNG) file. Next visualization images are generated by rendering visualization screenshots at one surface of the visualization images and metadata related to the data included in the visualization images at another surface of the visualization images (318). As discussed above, a visualization, for example a SAP Fiori® overview page, provides a summary of the data stored in the data source. Therefore, the screenshot also includes a summary of the data. The metadata of data may include details not included in the summary of data displayed at one of the surface of the portable electronic device. For example, when the underlying data is sales of laptops then one of the surface of a visualization image may display a sales summary that includes customer name and number of units bought. The other surface of the visualization image may include other details, for example, manufacturer of laptop, dealer name, details, for example memory, processing speed, etc., of the computer.

In one embodiment, visualization image is an instance of a visualization type. A visualization type represents a specific ‘entity’ type—for example, sales orders available through a specific backend system. This backend system might be able to present multiple sales orders, so each sales order could be represented as a visualization image.

Next the generated visualization images are arranged in one or more visualization image sets based on parameters related to the data included in the visualization images (320). The parameters include, for example, data source, data type, etc. In case when the parameter is data source then data from same data source may be included in the same visualization image set. In case when the parameter is data type then visualization image displaying financial data may be included in one set and visualization image displaying employee data may be included in another set, for example. The generated visualization images arranged in one or more visualization image sets are then displayed at the user interface of the portable electronic device (322). In one embodiment, the visualization image sets are displayed as a stack of visualization image sets positioned one above another. Different pre-defined UI layouts may be used to display the stack of visualization image sets at the UI of the portable electronic device. A stacked layout is used to display the visualization image set (stacked visualization image set) when no visualization image included in the visualization image set is selected at the UI of the portable electronic device. An exposed visualization layout is used to display the visualization image (exposed visualization set) when a visualization image from one or more visualization image sets has been selected. In one embodiment, the exposed visualization layout may display the selected visualization image at the UI. The other visualization images included in the set that are not selected may be shown as dots at the UI that represent these images. The UI may be provided with visualization set management classes that include several UI classes defined to allow a user to scroll through the visualization image sets, delete a visualization image in the visualization image set, place a selected visualization image back into the visualization image set, and search for a relevant visualization image from the visualization image sets.

In one embodiment, a visual image controller and the visualization set management classes may be used to control the display when a visualization image from the visualization image sets is selected. The controller controls the selection and viewing of another visualization image, which is not selected, from the exposed visualization set. In case of stacked visualization image set, the visualization set management classes allow a user to scroll through the visualization image sets, delete a visualization image in the visualization image set, place a selected visualization image back into the visualization image set, and search for a relevant visualization image from the visualization image sets.

The display of surface of the visualization image that includes metadata may be controlled by a back view controller. The back view controller may be included in the visualization set management classes. The back view controller is defined to display the other surface of the visualization image when a user selects a flip button at the display of the portable electronic device. In one embodiment the flip button is selected when the surface including the visualization screenshot is displayed at the UI of the portable electronic device. In one embodiment, a link may be inserted in one of the surfaces of the visualization image. When the link included in a displayed surface of visualization image is selected then a corresponding application or page associated with the link may be displayed at the user interface.

In case the request sent by a data presentation app to a UI service for UI generation file is not the first request (condition in 304 is false) then 306-310 are repeated to generate a UI generation file. In one embodiment, the received request is not a first request when the request sent from the app includes a timestamp. The data presentation app sends a timestamp along with the request to the UI service. The UI service may forward the timestamp to the UI frontend server that stores the timestamp received from the app. Next, in case the request is not the first request, a check is performed to determine whether there is a difference between the UI generation file, generated at 310, and a previously generated UI generation file (324). In one embodiment, the previously generated UI generation file is a UI generation file that is generated when the last request, prior to the current request, was received from the data presentation app. The UI generation file is generated based on the current request.

When a request is received then the UI frontend server compares the received timestamp with the stored timestamp, which corresponds to the time when the last request was received from the app. For example, consider that the time stamp of a first request received at the UI service from the app is Oct. 20, 2016 at 10:00 p.m. This time stamp is stored at the UI frontend server. UI generation file may then be generated based on this received request. Next a second request may be received from the data presentation app on Oct. 21, 2016 at 10:00 p.m. Another UI generation file may be generated based on this request. A check may be performed to detect any change between another UI generation file and the UI generation file generated based on the first request. The check may include detecting any change in the visualization template, visualization instance, or the data stored in a data source between the time period when the second request is received at the UI service and when the first request is received. In case, no change is detected (condition in 324 is false) then the UI service sends an empty response (326) to the app indicating that the UI generation file has not changed since the last request.

When a change is detected between the UI generation file and the previously generated UI generation file (condition in 324 is true) then the detected difference is forwarded to the data presentation app (328). The data presentation app may then render a visualization based on the received detected difference (330). After generation of visualization, steps 312-322 may be performed to display a visualization image corresponding to the visualization generated based on the detected difference.

In one embodiment, when the visualization rendered, at (330), based on the detected difference is related to a previously rendered visualization then the visualization images generated for the visualization replaces the visualization images generated for the previously rendered visualization. A previously rendered visualization is a visualization already rendered at the app based on the visualization template, visualization instance received in any of the previously received UI generation file. The previously rendered visualization may be related to the visualization when the detected difference are related to the visualization instance and/or visualization template that were used to generate the previously rendered visualization. For example, consider a visualization that is rendered for sales data of company ABC. A data value in the database table storing the sales data of company ABC may be changed. The new visualization images obtained in this case, based on the detected difference, replaces the visualization images generated for the previously rendered visualizations.

In one embodiment, when the visualization rendered, at (330), based on the detected difference is not related to a previously rendered visualization then visualization is generated based on the detected difference. The visualization images corresponding to the visualization are then included either in one or more existing visualization image sets or in a new visualization image set.

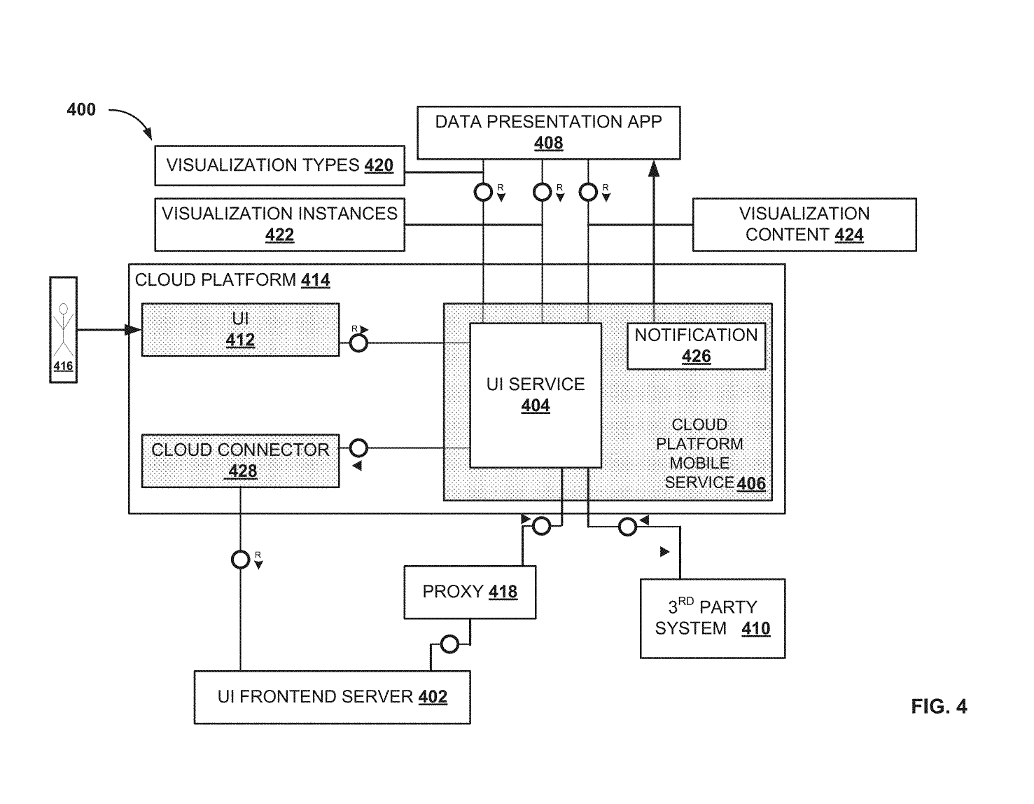

FIG. 4 is a block diagram illustrating a system 400 to display visualization images, according to an embodiment. The system 400 includes an UI frontend server 402 that connects with a UI service 404 hosted in a cloud platform mobile service 406. The cloud platform mobile service 406, for example SAP HANA® is a mobile application platform delivered as a service that enables a portable electronic device user to quickly create and operate mobile apps, for example, a data presentation app 408. The cloud platform mobile service 406 exposes APIs that allows connecting to the frontend server 402, 3^{RD} party system 410, or a UI 412 provided at a cloud platform 414 hosting the cloud platform mobile service 406. The UI 412 may allow a user 416 to define new visualization type that is added to the UI frontend service 402. The UI service 404 receives visualization instances from the UI frontend server 402 via a proxy 418 or directly from 3^{RD} party system 410. In one embodiment, the UI service 404 sends visualization types 420, visualization instances 422 and visualization content 424 to the data presentation app 408.

The cloud platform mobile service 406 may also send notifications 426 to the data presentation app 408 when a new visualization is added at the UI service. The UI service 404 may send a request to UI frontend service 402 via a cloud connector 428 to check about any update at the UI frontend service 402.

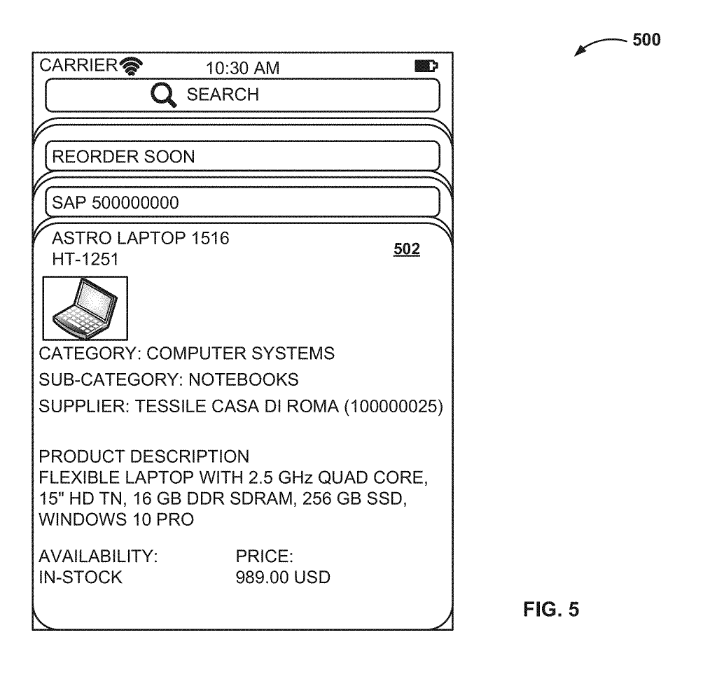

FIG. 5 is an exemplary block diagram illustrating a user interface 500 of a portable electronic device displaying several visualization images, according to an embodiment. As shown, the visualization images are stacked in several visualization sets. A visualization image 502 displays a screenshot of purchase order related to sales of a laptop. As visualization image 502 is a part of an image set that includes another visualization image there is one more visualization image shown behind the displayed visualization image.

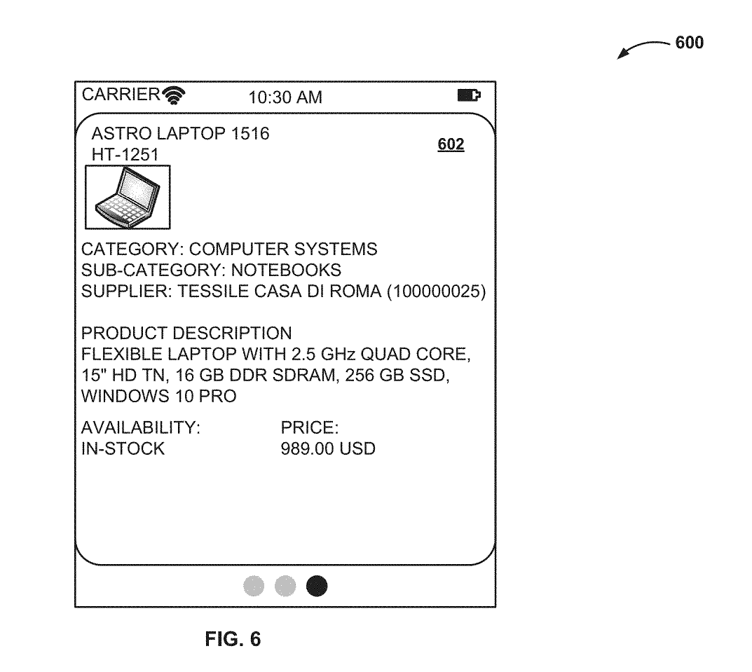

FIG. 6 is an exemplary block diagram illustrating a user interface 600 of a portable electronic device displaying a surface 602 of a visualization image when one of the visualization image is selected, according to an embodiment. The surface 602 displays details of a laptop purchase in an object page template. The three dots on the user interface 600 indicates that there are three more visualization images in the visualization set that includes the visualization image 600.

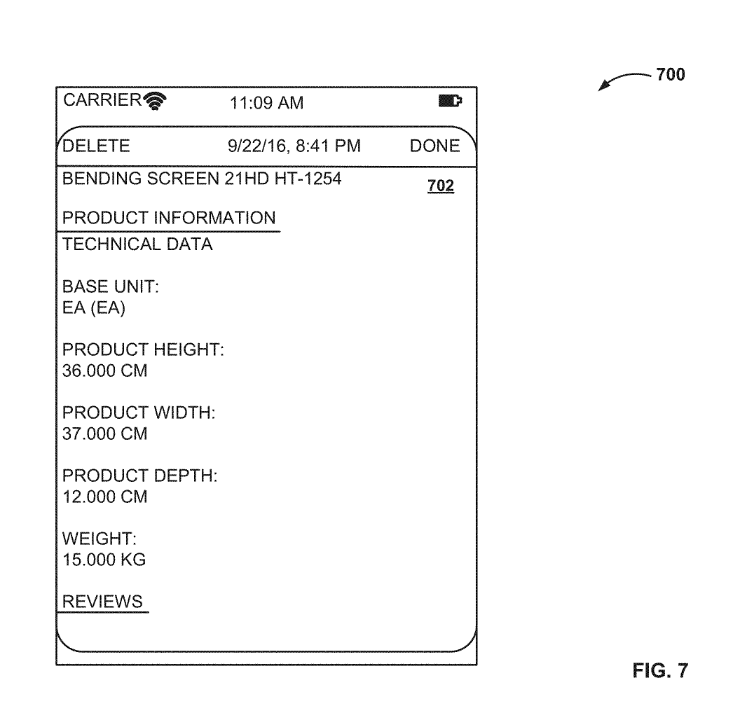

FIG. 7 is an exemplary block diagram illustrating a user interface 700 of a portable electronic device displaying another surface 702 of the visualization image 600 displayed in FIG. 6, according to an embodiment. As shown, the surface 702 includes metadata related to the laptop the sales data of which are included in the surface 602 of the user interface 600 (FIG. 6). The metadata includes additional data related to the laptop, for example, height, width, depth, and weight.

Some embodiments may include the above-described methods being written as one or more software components. These components, and the functionality associated with each, may be used by client, server, distributed, or peer computer systems. These components may be written in a computer language corresponding to one or more programming languages such as functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

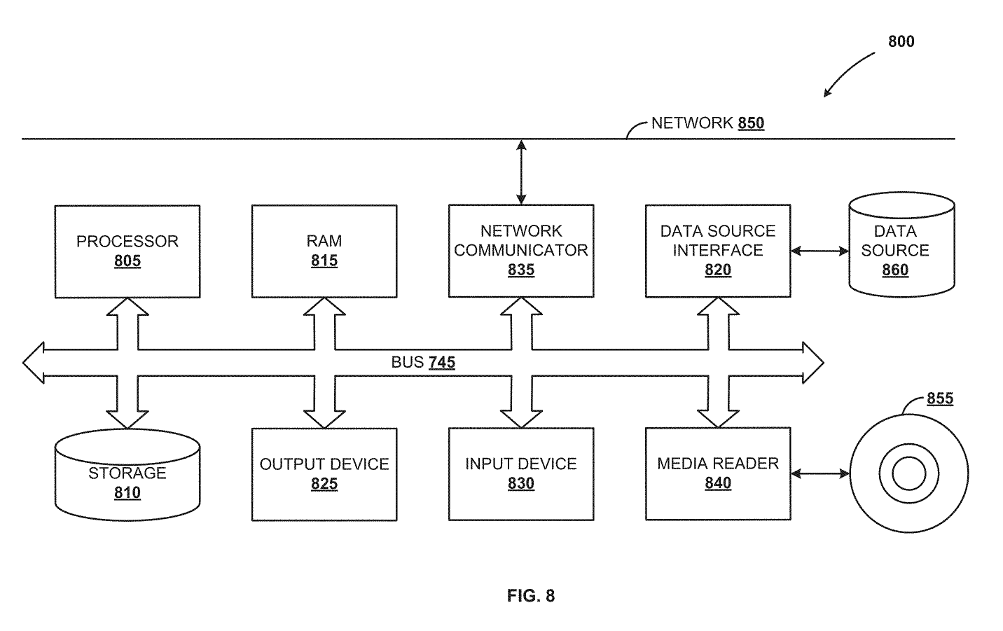

FIG. 8 is a block diagram of an exemplary computer system 800. The computer system 800 includes a processor 805 that executes software instructions or code stored on a computer readable storage medium 855 to perform the above-illustrated methods. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as a semantic layer.

A data source is an information resource. Data sources include sources of data that enable data storage and retrieval. Data sources may include databases, such as relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to display a plurality of visualization images, the method comprising:
a data presentation application executing at a portable electronic device, rendering a plurality of visualizations based on an user interface (UI) visualization file;
capturing, at the data presentation application, a plurality of screenshots corresponding to the rendered plurality of visualizations;
generating, at the data presentation application, a plurality of visualization images by rendering the visualization screenshots at one surface of the plurality of visualizations and metadata related to the data on another surface of the plurality of visualization images, and
displaying, at a user interface of the portable electronic device, the generated plurality of visualization images.

2. The computer implemented method of claim 1, further comprising:
arranging the plurality of visualization images in one or more visualization image sets based on parameters related to the data, and
displaying the visualization images arranged in one or more visualization sets at the user interface of the portable electronic device.

3. The computer implemented method of claim 1, further comprising:
detecting, at a UI frontend server, a difference between the UI generation file and a previously generated UI generation file.

4. The computer implemented method according to claim 3, further comprising:
when the detected difference is related to the previously generated UI generated file, replacing the plurality of visualization images corresponding to the previously generated UI generation file with new visualization images corresponding to the detected difference.

5. The computer implemented method according to claim 3, further comprising:
sending a request from the data presentation app to a UI service to receive the UI generation file;
detecting whether the sent request is a first request from the data presentation app to the UI generation file; and
based on the detection, detecting the difference between the UI generation file and the previously generated UI generation file.

6. The computer implemented method according to claim 1, further comprising:
identifying a visualization instance identifier corresponding to a visualization instance stored at the UI frontend server; and
storing the visualization instance identifier and a visualization template at the UI service.

7. The computer implemented method according to claim 6, further comprising:
retrieving, from the UI frontend server, the visualization instance corresponding to the visual instance identifier stored at the UI service; and
generating the UI generation file based on the retrieved visualization instance and the stored visualization template.

8. A computer system for displaying a plurality of visualization images, the computer system comprising:
a memory to store a program code; and
a processor communicatively coupled to the memory, the processor configured to execute the program code to:
render a plurality of visualizations based on an user interface (UI) visualization file at a data presentation application executing at a portable electronic device;
capture, at the data presentation application, a plurality of screenshots corresponding to the rendered plurality of visualizations;
generate, at the data presentation application, a plurality of visualization images by rendering the visualization screenshots at one surface of the plurality of visualizations and metadata related to the data on another surface of the plurality of visualization images; and
display, at a user interface of the portable electronic device, the generated plurality of visualization images.

9. The system according to claim 8, wherein the processor further executes the program code to:
arrange the plurality of visualization images in one or more visualization image sets based on parameters related to the data; and
display the visualization images arranged in one or more visualization sets at the user interface of the portable electronic device.

10. The system according to claim 8, wherein the processor further executes the program code to:
detect, at a UI frontend server, a difference between the UI generation file and a previously generated UI generation file.

11. The system according to claim 10, wherein the processor further executes the program code to:
when the detected difference is related to the previously generated UI generated file, replace the plurality of visualization images corresponding to the previously generated UI generation file with new visualization images corresponding to the detected difference.

12. The system according to claim 10, wherein the processor further executes the program code to:
send a request from the data presentation app to a UI service to receive the UI generation file;
detect whether the sent request is a first request from the data presentation app to the UI generation file; and
based on the detection, detect the difference between the UI generation file and the previously generated UI generation file.

13. The system according to claim 8, wherein the processor further executes the program code to:
identify a visualization instance identifier corresponding to a visualization instance stored at the UI frontend server; and
store the visualization instance identifier and a visualization template at the UI service.

14. The system according to claim 13, wherein the processor further executes the program code to:
retrieve, from the UI frontend server, the visualization instance corresponding to the visual instance identifier stored at the UI service; and
generate the UI generation file based on the retrieved visualization instance and the stored visualization template.

15. An article of manufacture including a non-transitory computer readable storage medium to tangibly store instructions, which when executed by a computer, cause the computer to:
render a plurality of visualizations based on an user interface (UI) visualization file at a data presentation application executing at a portable electronic device;
capture, at the data presentation application, a plurality of screenshots corresponding to the rendered plurality of visualizations;
generate, at the data presentation application, a plurality of visualization images by rendering the visualization screenshots at one surface of the plurality of visualizations and metadata related to the data on another surface of the plurality of visualization images; and
display, at a user interface of the portable electronic device, the generated plurality of visualization images.

16. The article of manufacture of claim 15, further comprising instructions which when executed by the computer further causes the computer to:
arrange the plurality of visualization images in one or more visualization image sets based on parameters related to the data; and
display the visualization images arranged in one or more visualization sets at the user interface of the portable electronic device.

17. The article of manufacture of claim 15, further comprising instructions which when executed by the computer further causes the computer to:
detect, at a UI frontend server, a difference between the UI generation file and a previously generated UI generation file.

18. The article of manufacture of claim 17, further comprising instructions which when executed by the computer further causes the computer to:
when the detected difference is related to the previously generated UI generated file, replace the plurality of visualization images corresponding to the previously generated UI generation file with new visualization images corresponding to the detected difference.

19. The article of manufacture of claim 17, further comprising instructions which when executed by the computer further causes the computer to:
send a request from the data presentation app to a UI service to receive the UI generation file;
detect whether the sent request is a first request from the data presentation app to the UI generation file; and
based on the detection, detect the difference between the UI generation file and the previously generated UI generation file.

20. The article of manufacture of claim 19, further comprising instructions which when executed by the computer further causes the computer to:
identify a visualization instance identifier corresponding to a visualization instance stored at the UI frontend server; and
store the visualization instance identifier and a visualization template at the UI service.
